(19) United States
(12) Patent Application Publication
(10) Pub. No.: US 2003/0209502 A1
(43) Pub. Date: Nov. 13, 2003

(54) Ozone water treatment system

(76) Inventors: Maurice Lacasse, Chambly (CA); Pierre Marchetti, Deauville (CA)

Correspondence Address: BROUILLETTE KOSIE PRINCE, 25th Floor, 1100 Rene-Levesque Boulevard West, Montreal, QC, H3B 5C9, CA

(21) Appl. No.: 10/434,215

(22) Filed: May 9, 2003

(30) Foreign Application Priority Data
May 10, 2002 (CA) 2,385,828

(51) Int. Cl. C02F 1/78

(52) U.S. Cl. 210/760; 210/192

(57) ABSTRACT

The present invention relates to a system for water treatment using ozone. More particularly to a system using an improved ozone generator that is simple, compact, portable, efficient and easy to clean.

### FIELD OF THE INVENTION

The present invention relates to a system for water treatment using ozone. More particularly to a system using an improved ozone generator that is simple, compact, portable, efficient and easy to clean.

### BACKGROUND OF THE INVENTION

In today's world, water sources for human consumption or other uses can often contain contaminants and various pollution elements such as living organisms (bacteria, viruses, etc. . . . ) and organic and inorganic substances causing unwanted odor and color. Naturally it is desired to reduce the amount of contaminants in water, especially if the water is destined to be consumed by people or is used in a pool or spa.

Previous methods for reducing contaminants in water have used, for example chlorine, and ozone. Of these substances ozone recently has become the more and more popular since ozone is one of the most powerful oxidizers and disinfectants available.

Swimming pool water differs significantly from drinking water, although almost universally potable water is used to fill pools, initially. Most state health codes for pools mandate a pH between 7.2 and 7.8. In addition, many of those codes also stipulate a minimum, and sometimes a maximum, level for a sanitizer, and recommend values for calcium hardness and bicarbonate alkalinity. The only sanitizers currently permitted are hypochlorous acid, HOCl (customarily referred to as chlorine in the pool industry), and less often hypobromous acid, HOBr (likewise, referred to as bromine).

With the exception of dichloro-isocyanuric acid, all compounds that produce chlorine or bromine in pool water influence the pH. It is therefore necessary to add either an acidic or caustic substance to maintain the pH. This means that pools have two injection systems: one for the selected sanitizer, and another one for the pH control.

The hypochlorous acid, often referred to as “free chlorine,” can combine with ammonium ions in the water to form monochloramine, and to a much lesser degree dichloramine. These chloramines are the main source of irritation for pool patrons, because they have a strong chlorine-like odor, and cause the typical “swimmer's red eye” and itching. While a pool with a concentration of several mg/L chlorine is essentially odor-free, chloramine levels as low as 0.1-0.2 mg/L are noticeable.

The requirement for maintaining chlorine levels at or above the specified minima is meant to ensure that the pool water remains free of harmful microorganisms. Bacteria, such as E. coli or Pseudomonas aeruginosa, that may be found in pool or hot whirlpool environments are easily inactivated when the required sanitizer level is continuously maintained. Exceptions are Giardia and Cryptosporidium, which are difficult to inactivate in a pool environment. Since the 1993 Crypto outbreak (drinking water) in Milwaukee, Wis., there have been a number of similar instances relating to swimming pools in Wisconsin, elsewhere, as well as waterparks in Georgia and California. To be effective, chlorine must have an estimated CT-value of 30 to 630 mg-min/L (where C is average concentration and T is average time) at 5° C. to destroy 99% of the protozoa G. muris. With such high concentrations and/or time, it is clear that chlorine is completely ineffective in providing inactivation within a reasonable time span, and at levels tolerable to the bathers. By comparison, ozone at CT-values around 1.8 to 2.0 mg-min/L can be effective for the same purpose.

Most known U.S. ozone pool water treatment systems are, however, fairly small when compared to those required by European codes, such as the German DIN 19623. The typical U.S. installation ozonates a side stream after the filter, with some units treating only 8%-10% of the total filtration flow, and others recommending 25% side stream ozonation for 4 minutes at 0.4 mg/L.

See, for example, U.S. Pat. No. 6,274,052 (Hartwig) and U.S. Pat. No. 6,277,288 (Gargas) for a description of known ozone pool water treatment systems.

When dissolved in water, ozone exhibits biocidal qualities at concentrations below 0.5 parts per million. Ozone is a semistable gas formed of three oxygen atoms, instead of the two atoms that form oxygen gas. Ozone is most typically produced by an electrical arc discharged through air causing oxygen atoms to combine with an oxygen free radical that is formed. Ozone rapidly undergoes reaction to revert to more stable oxygen, releasing an oxygen free radical in the process. Two such free radicals can combine to form an oxygen molecule or the free radicals can oxidize an oxidizable substrate.

Ozone not only kills bacteria, but also inactivates many viruses, cysts and spores. In addition, ozone oxidizes many organic chemical compounds, including chloramines, soaps, oils and other wastes thereby rendering them harmless to the environment. Accordingly, ozone may be used for a number of purposes, including: purification of water used for drinking, in food cleaning and processing, in ice machines, in swimming pools and spas and waste water treatment. Copious data is available with respect to ozone in any handbook of Chemistry and Physics, as well as many other sources. The International Ozone Association is a particularly good source for information on ozone.

Although ozone is especially beneficial for breaking down certain contaminants in water, obtaining a sufficiently high concentration in water to be effective is difficult for two reasons. First, it is difficult to economically and reliably generate large amounts of ozone. Second, it is difficult to infuse ozone into contaminated water at a sufficiently high dosage to achieve the full potential of ozone as a powerful oxidant.

Ozone is typically generated by creating an electrical corona discharge between two energized electrodes in ambient air or in another oxygen containing gas. The electrodes are typically separated by a dielectric material, such as a glass, or an air gap separation may be provided. The corona discharge is an ionization of the air and is visually indicated by the presence of a pale violet or bluish color in the area between and surrounding the electrodes. A wide assortment of electrode configurations have been developed to try to improve the performance of the basic corona discharge ozone generator.

Known ozone generators employ a high voltage alternating sinusoidal current operating at frequencies of between about 60 and 1,000 Hz and voltages frequently above 20 kilovolts. Such generators require high voltage transformers which are difficult to construct and insulate and which cause the generator to be very large in size.

An increase in ozone production efficiency may be obtained by cooling and drying the intake air for a corona discharge generator as shown, for example, in U.S. Pat. No. 3,884,819 (Schultz et al.). To increase the amount of ozone that is generated, ozone generating tubes have been combined into modular units as shown, for example, in U.S. Pat. No. 4,035,657 (Carlson), and U.S. Pat. No. 3,798,457 (Lowther). In addition, U.S. Pat. No. 4,138,724 (Kawauchi) discloses a control system for a plurality of ozone generators and includes a computer for adjustably controlling the power delivered to the ozone generators in response to a predetermined program or a user input of ozone demand.

Because ozone has a half-life of only about 22 minutes in ambient air before dissociating back to oxygen, a process requiring ozone must desirably have an ozone generator in relative close proximity to the intended point of application of the ozone. Thus, an ideal ozone generator is desirably compact, relatively simple in construction, consumes little electricity, and produces little waste heat while producing a high concentration of ozone.

Most if not all small ozone generators heretofore known, due to economical considerations are not provided with air dryers. As a result, nitric acid will build up on the dielectric members. Contaminants from the feed gas will also form a deposit on the surface area connecting the two electrodes. As a result, the impedance of the generator will be reduced and will eventually load down the transformer below the corona inception voltage or if an insulating material which will form surface tracks is used, the insulator is usually destroyed. Because of the required operating frequencies and voltages of most known generators and the fragile nature of the electrics of the reaction chamber, such deterioration will require maintenance and repair not only to the ozone generation chamber but to other electrical/electronic components of the ozone generator. To prevent this, the generator will need periodic removal and cleaning. In most ozone generators this is a difficult process. To alleviate this problem, U.S. Pat. No. 6,129,850 (Martin et al.) describes a disposable ozone generator. Small gas-tight ozone generators are also available but are commonly expensive to manufacture and difficult to disassemble for cleaning. Attempts to produce easy to clean ozone generators have been made. See for example U.S. Pat. No. 5,094,822 (Dunder) and U.S. Pat. No. 5,587,131 (Malkin et al.). However, there remains ample room for improvement.

In many other known ozone generators, the electrodes are allowed to function until they break down at which point the generator is shut down and the electrodes are replaced. This method while common is often not desirable since the cost of replacing electrodes can become high. It would therefore be useful to have a device which instead of allowing electrodes to burn out would monitor the output of an ozone generator and then send a warning signal to the operator when the output is reduced under a predetermined level and eventually shut down the electrodes when it is determined that the device is in danger of burning out. In this way, the operator may clean the generation chamber and/or do such other maintenance or repair as may be required.

Usually, ozone gas is supplied to water by pumping the water through a venturi and allowing the venturi to draw ozone into the water as it passes through the throat of the venturi under the natural suction created by the venturi. See, for example, U.S. Pat. Nos. 5,785,864 (Teran et al.), 6,090,294 (Teran et al.) and U.S. Pat. No. 6,132,629 (Boley). However, the violent turbulence found in the throat of the venturi causes a proportion of the ozone to revert to oxygen so that an excess of ozone must be added to ensure that sufficient ozone is available in the water to oxidize pathogens and other oxidizable contaminants.

Another method of applying ozone consists in admitting an ozone-air or ozone-oxygen mixture to the bottom of a basin referred to as an ozone contact chamber. Gas dissolution is achieved utilizing a network of piping equipped with gas diffusers. See for example U.S. Pat. No. 3,945,918 (Kirk) and U.S. Pat. No. 4,076,617 (Bybel et al.). The small bubbles of gas produced through the diffusers rise through the water in the contact chamber and the component gasses dissolve to essentially their saturation constant for the ambient conditions.

All ozone contact devices are designed to achieve the best conditions for its dissolution. As a result, each of the component gasses dissolve to essentially their saturation concentration. Later, as the water passes through other portions of the treatment systems, the equilibrium conditions (temperature, pressure) of the water may change. Hence, some of the dissolved gas can come out of solution, resulting in “air binding” of filter beds, pumps, piping, or other equipment. If ozone is added at the beginning of the treatment process, very small gas bubbles released can interfere with the sedimentation process by having tiny bubbles attach themselves to suspended particles causing them to float rather than settle as desired.

For these reasons and because ozone is a toxic and corrosive gas which is considered to be a pollutant by The United States Environmental Protection Agency (EPA), special provisions must be made for the containment and removal of the excess ozone. The contact chambers must be equipped with a gas tight cover to allow collection of the off gas and its discharge through a device capable of removing its ozone content. One of the more usual solutions is to pass the water through a vacuum degassifier, i.e., a closed vessel operating at less than atmospheric pressure. The fluid, in this case water, is usually sprayed into such vessel or distributed over packing installed in the vessel to provide the large liquid surface film required for efficient gas transfer. Although these vacuum degassifiers provide the desired results they are costly to build, install and operate. The vessels are of some height, sometimes reaching 20 feet or more. Pumping is required to elevate the water to the top of the vessel. If spray nozzles are used for efficient distribution of the water, additional pressure losses are generated so additional pump pressure is necessary. Large volumes of water are required to satisfy the potable water requirements of a city, resulting in appreciable equipment size and pumping costs. Other apparatuses to remove excess ozone are known. See for example U.S. Pat. No. 5,061,302 (Zuback) and U.S. Pat. No. 5,397,461 (Augustin). However, such apparatuses are expensive and difficult to clean.

Thus, despite the numerous benefits available from using ozone to decontaminate water, its use still presents a number of technical challenges particularly in generating ozone efficiently and also in effectively transferring the ozone into the water. While large scale commercial ozone generating systems are available, such systems typically have a high capital cost, require continuing maintenance, are physically too large and cumbersome, and are too energy inefficient to be readily adapted to many smaller potential industrial and commercial applications.

Additionally, known spa and small pool water treatment apparatuses using ozone generators often still require the use of chlorine. This is because currently existing ozone generators are often not capable of generating ozone in sufficient quantities to act as a sole treatment agent. Indeed, large quantities of ozone are difficult to generate at low cost. Another reason is the poor management of excess or residual ozone.

Continuing efforts are being made to improve water treatment methods and apparatuses. Consider, for example, U.S. Pat. No. 5,178,755 (LaCrosse), that discloses a method for treating wastewater with ozone, that has been enhanced by treatment with ultra-violet light. In this system, a large amount of ozone is generated and inserted at several points in the effluent flow, including insertion in each of the three clarifiers. This system utilizes large quantities of ozone at a relatively high cost and low efficiency. Furthermore, in this system; water is continually re-circulated based upon a timer and the system does not automatically respond to changes in the influent quality or discharge water from the system based upon water quality parameters.

These known purification apparatuses have drawbacks. Notwithstanding the existence of such prior art treatment systems, it remains clear there is a need for a water treatment system that is simple, compact, portable, and efficiently uses the generated ozone in the treatment of the water, and in this respect, the present invention addresses these needs.

Although modular ozone water treatment systems have been suggested, none are both easily transportable and capable of supplying the need of a small municipality. See, for example, U.S. Pat. No. 5,427,693 (Mausgrover et al.), U.S. Pat. No. 5,711,887 (Gastman et al.) and U.S. Pat. No. 6,027,642 (Prince et al).

### SUMMARY OF THE INVENTION

Therefore, the principal object of this invention is to provide an improvement that overcomes the aforementioned inadequacies of the prior art devices and provides an improvement that is a significant contribution to the advancement of the water purification/filtration art.

It is an object of the present invention to provide an apparatus and associated method for generating ozone efficiently and for effectively transferring the ozone into water to thereby treat the water with a high concentration of ozone.

It is also an object of the invention to provide an ozone generator which is compact and simple to build and operate.

It is another object of the present invention to provide a small gas-tight ozone chamber for use in ozone generators which is easy to disassemble and clean.

It is an object of the invention to provide an ozone generator having means to control its operation such that a signal will be triggered when there is a need for maintenance or cleaning and preferably means to interrupt it operation if such maintenance or cleaning is not timely made.

It is a further object of the present invention to provide a system and/or method capable of ozonating small pool/spa water without the need for additional treatment or chemical agent, thereby overcoming various deficiencies and shortcomings of the prior art, including those outlined above.

Furthermore, with the increased use of ozone in the treatment of water it would be useful to allow a water treatment system, including an ozone generator, to be completely bundled in a single unit, for ease of transportation and installation.

It is also an object of this invention to provide an ozone water treatment system that is adapted to serve the needs of a small municipality while being fully contained in an easy to move housing, which is preferably a standard container.

It will be understood by those skilled in the art that one or more aspects of this invention can meet certain objectives, while one or more other aspects can meet certain other objectives. Each objective may not apply equally, in all instances, to every aspect of the present invention. As such, the following objects can be viewed in the alternative with respect to any one aspect of the present invention.

Other objects and further scope of applicability of the present invention will become apparent from the detailed descriptions given herein; it should be understood, however, that the detailed descriptions, while indicating preferred embodiments of the invention, are given by way of illustration only, since various changes and modifications within the spirit and scope of the invention will become apparent from such descriptions.

These and other objects, features and advantages of the present invention are provided by a system for the treatment of water comprising:

a. ozone generator means for generating ozone gas;

b. venturi means for introducing said ozone gas into said water;

c. diffuser means for diffusing said ozone in said water;

d. a contact chamber for allowing said ozone gas to dissolve in said water.

The system can also comprise:

a. gas removal means for removing excess ozone gas from said water; and

b. ozone destruction means for destroying said excess ozone gas.

The system may also comprise:

a. a chamber having one or more inlets through which water may enter said chamber, an ozone gaz collecting portion located near the top of said chamber and an ozone gas outlet connected to said gas collecting portion; and

b. a flotation device within said chamber, said flotation device being disposed such that when sufficient water is within said chamber said flotation device will close said outlet and will open said outlet when a predetermined quantity of ozone gas accumulates in said gas collecting portion.

In another aspect of the invention the ozone generator means comprise:

a. ozone generation means having a first state in which the ozone generation means generates ozone, and a second state in which the ozone generation means does not generate ozone;

b. ozone detection means for determining how much ozone is being generated by the ozone generation means; and

c. a control circuit connected to said ozone detection means and said ozone generation means, such that said control circuit can cause the ozone generation means to pass from said first state to said second state if said measure is under a predetermined value.

In still another aspect of the invention the ozone generator means comprise:

a. ozone generation means having a first state in the ozone generation means generates ozone and a second state in which the ozone generation means does not generate ozone;

b. current measuring means for determining how much current is being consumed by said ozone generation means;

c. control means connected to said current measuring means and said ozone generation means, such that said control circuit can cause the ozone generation means to pass from said first state to said second state if said measure is above a first predetermined value.

In still another aspect of the invention the control means can also cause the ozone generator to interrupt its operation if said measure is under a second predetermined value.

A method for treating water is also provided comprising the steps of:

a. providing an ozone generator means comprising:

i. an ozone generator having an first state in which the ozone generator generates ozone, and a second state in which the ozone generator does not generate ozone;

ii an ozone detection means for determining how much ozone is being generated by the ozone generator; and

iii a control circuit connected to said ozone detection means and said ozone generator, such that said control circuit can cause the ozone generator to pass from said first state to said second state if said measure is under a predetermined value;

b. determining how much ozone is needed to reduce a projected level of contaminants in the water stream to a harmless level;

c. introducing more ozone into the water than the needed amount of ozone;

d. maintaining the ozone in the water for a period of time sufficient to allow for:

i. the reduction of the projected level of contaminants; and

ii a predetermined quantity of ozone to become dissolved in said water.

In another aspect, the method comprises the following steps:

a. providing an ozone generator means comprising:

i. an ozone generator having a first state in which the ozone generator generates ozone and a second state in which the ozone generator does not generate ozone;

ii. current measuring means for determining how much current is being consumed by said ozone generation means;

iii. control means connected to said current measuring means and said ozone generation means, such that said control circuit can cause the ozone generation means to pass from said first state to said second state if said measure is above a predetermined value.

b. determining how much ozone is needed to reduce a projected level of contaminants in the water stream to a harmless level;

c. introducing more ozone into the water than the needed amount of ozone;

d. maintaining the ozone in the water for a period of time sufficient to allow for:

i. the reduction of the projected level of contaminants; and

ii a predetermined quantity of ozone to become dissolved in said water.

In another aspect all said means are installed in an enclosure such that the water treatment system can be relocated by moving the enclosure and such that the water treatment system can treat a water source external to said enclosure without being removed from said enclosure.

In still another aspect, there is provided an ozone generating apparatus comprising:

a. an outer cylinder made out of an electrically conducting and ozone resistant material, said outer cylinder extending along a longitudinal central axis and having a first end and a second end;

b. an intermediate cylinder made of glass or quartz, said intermediate cylinder extending along said axis within said outer cylinder and defining an outer chamber with said outer cylinder and having a third end and a fourth end;

c. an inner cylinder made out of an electrically conducting material, said inner cylinder extending along said axis within said intermediate cylinder and forming an inner chamber;

d. a first plug made of an ozone resistant material adapted to seal said first end and defining an oxygen containing gas inlet;

e. a second plug made of an ozone resistant material adapted to seal said second end and defining an ozone outlet;

f. a third plug made of an ozone resistant material adapted to seal said third end;

g. a fourth plug made of an ozone resistant material adapted to seal said fourth end;

h. an electrode in electrical contact with said inner cylinder and adapted to be connected to an external power source;

wherein a continuous gas path is defined between said inlet and said outlet and said apparatus may be easily disassembled for cleaning.

### BRIEF DESCRIPTION OF THE DRAWINGS

A more complete understanding of the invention can be obtained by reference to the accompanying drawings in which:

FIG. 1 is a schematic diagram of an ozone generation apparatus according to the present invention;

FIG. 2 is another schematic diagram of the ozone generation apparatus shown in FIG. 1;

FIG. 3 is a schematic diagram of a venturi for injecting ozone in a water stream according to the present invention;

FIG. 4 is a schematic diagram of a spa water treatment apparatus using the ozone generation apparatus shown in FIG. 2;

FIG. 5 is a cross-sectional side view of the ozone generating chamber shown in FIG. 2;

FIG. 6 is a detailed view of the air intake and ozone outlet of the ozone generating chamber shown in FIG. 5;

FIG. 7 is a schematic diagram of an ozone generation apparatus according to the present invention for use in a potable water treatment system;

FIG. 8 is a schematic view of a self contained mobile ozone water treatment apparatus according to the present invention;

FIG. 9 is a schematic view of another self contained mobile ozone water treatment apparatus according to the present invention;

FIG. 10 is a perspective view of the housing of the modular ozone water treatment apparatus as shown in FIG. 9.

### DETAILED DESCRIPTION OF THE PREFERRED EMBODIMENTS

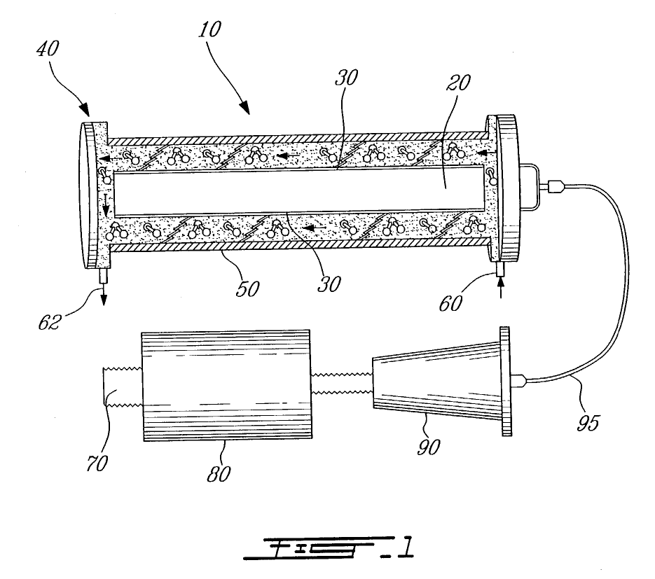

FIG. 1 shows an ozone generator 10 according to a first example embodiment of the present invention. In this embodiment the ozone generator may comprise a first electrode 20, which may be encased in a glass tube 30. The first electrode 20 may be made for instance from stainless steel or an other appropriate material which conducts electricity and is resistant to oxidation. The first electrode 20 and the glass tube 30 may then be placed inside an ozone chamber 40, having an electrically conducting wall 50 which also functions as a ground electrode. Ground electrode 50 may be made of stainless steel. Ozone chamber 40 also has openings 60 and 62 through which oxygen may be introduced and ozone may be extracted.

In the present embodiment the ozone generator 10 may be powered by a low volt power source 70 connected to a control circuit 80 itself connected to a high voltage transformer 90. The low voltage power source 70 may for instance be a normal wall power source, supplying 110 volts.

As can be see in FIG. 1, the low volt power source 70 is connected to a control circuit 80. The control circuit 80 controls how much power is supplied to the first electrode 20, and also monitors the performance of the ozone generator 10. The control circuit 80, is preferably configured such as to signal an alarm and a need for cleaning if the performance of the ozone generator becomes too low. In a preferred embodiment, the control circuit monitors the level of current drawn through the ozone generator. When such current level exceeds a first predetermined level, the operation of the ozone generator is stopped. The control circuit is preferably designed to also interrupt its operation when such current level falls under a second predetermined level. In a preferred embodiment, a normal current level is determined and the first and second predetermined levels are calculated as a variation from said normal level. Such variation may be either a set amp level or a percentage variation from the normal level. In one example, the normal level is set at 0.7 amp while the first predetermined level is set at 1.0 amp and the second predetermined level is set at 0.5 amp. In the present embodiment the control circuit 80 is an integrated control chip though in other embodiments other means may be used.

The control circuit 80 is connected to a voltage transformer 90 which allow it to transform the power supplied from the low volt power source 70 to a high voltage level such as 30,000 volts. This allows the control circuit 80, to supply high voltage power to the first electrode 20. The first electrode 20 is connected to the voltage transformer 90 through connection means 95. Connection means 95 can be any suitable means, such as a high voltage power cable.

In one embodiment of the present invention the combination of an ozone chamber with a first energized electrode, a second ground electrode, a control circuit, and a power supply may be considered a single ozone generator. This system can be very useful in that the modularity of the ozone generators allows for multiple ozone generators to be included in a single water treatment system with little difficulty. Thus, for small scale water treatment systems such as for instance a water treatment system for a single pool or hot tub, may only have a single ozone generator, while a large municipal water treatment system may have a large number of ozone generators (for example 30 to 36) arranged in water cooled cells each containing a plurality (for example 6) ozone generators.

Therefore, by knowing the ozone producing capacity of a single ozone generator, it therefore becomes possible to calculate how many ozone generators are needed in any given system.

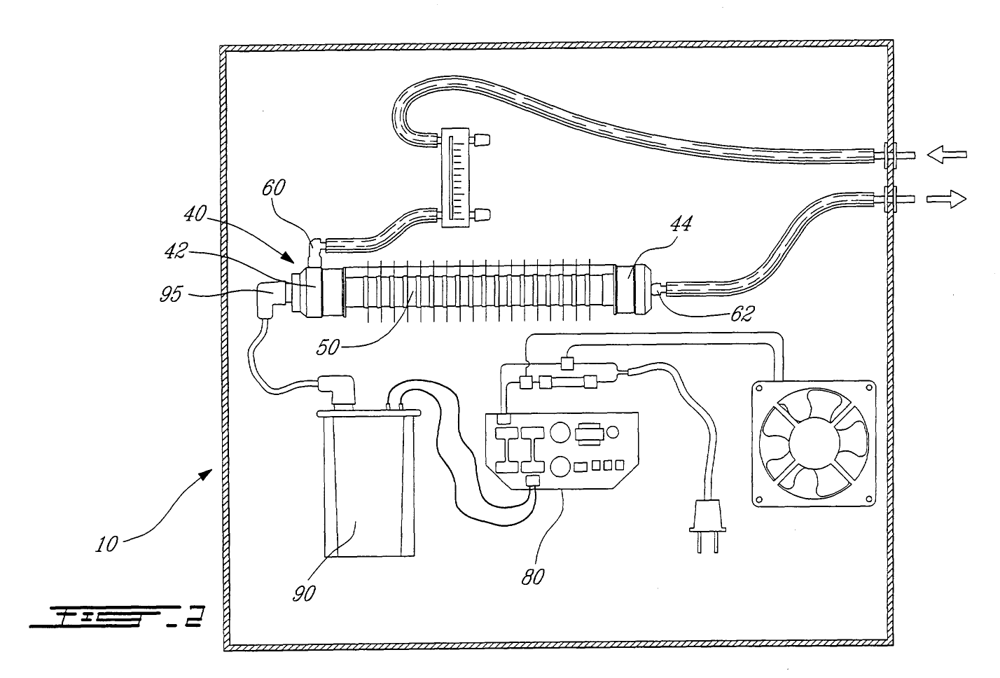

FIG. 2 shows a more particular embodiment of ozone generator 10. This embodiment shows an ozone generating chamber 40 that may be dismounted easily for the purpose of cleaning the first electrode 20, the glass tube 30, and the ground electrode 50.

As explained above, once the ozone generator 10 has been in use for a long period of time the first electrode 20, the glass tube 30, and the ground electrode 50, may become covered in pollutants such as nitric acid which result from the ozone generating process. This happens in particular if ambient air is used to fuel the ozone generator, rather than pure oxygen or at least pre-dried and filtered air.

As the electrodes become covered in pollutants, the electrical discharge becomes less and less efficient until it eventually ceases to produce ozone. If left on too long, the electrodes may even bum out and need to be replaced. Damage may also result to the control circuit 80.

In the embodiment of the invention shown in FIG. 2, the ozone generator has been designed such that when the control circuit 80 detects that ozone generation efficiency has fallen beneath a first predetermined level or that the ozone generator is drawing more that a first predetermined level of current, the ozone generator signals a user that the ozone generator is in need of cleaning. At this point the user or operator should proceed with cleaning the ozone generator. In one embodiment, if such cleaning is not done when the efficiency fall beneath a second predetermined level or when the ozone generator is drawing more than another higher level of current, the ozone generator again signals the user and stops functioning.

In the embodiment shown in FIG. 2, the ozone generator has been designed so that the cleaning process becomes quite simple. First off the user disconnects the air supply tube and the ozone exit tube from openings 60 and 62 respectively. The user then disconnects the ozone chamber 40 from the power supply by disconnecting cable 95. The ozone chamber 40 can now be removed from the ozone generator. Preferably the ozone chamber 40 is fixed to the housing by snap fit means or other means not requiring the use of tools.

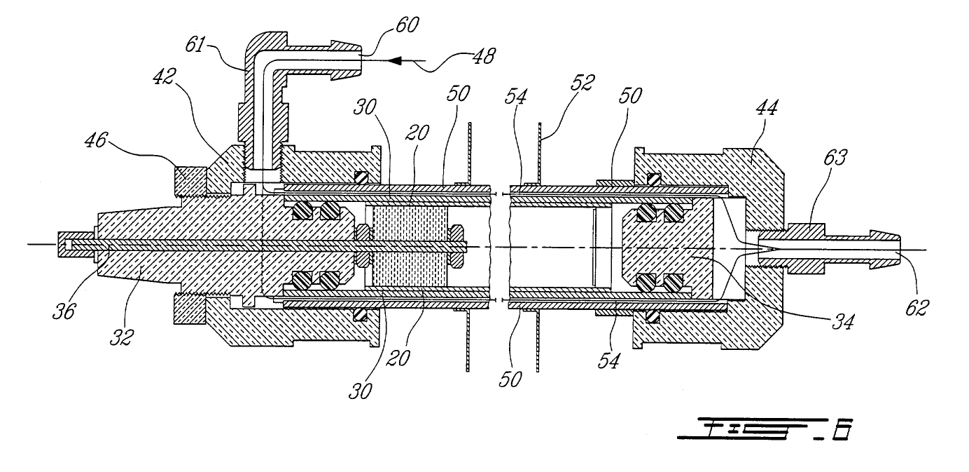

At this point the end caps 42, and 44 can be removed from the ozone chamber and the first electrode 20 and the glass tube 30 can be removed and cleaned. Again, the caps are designed to be easily removed without the need to use of special tools and ideally without the use of any tools. FIG. 6 shows a more detailed view of the cap construction. After the electrodes and the glass tube have been cleaned, the ozone chamber can be reassembled and replaced within the ozone generator.

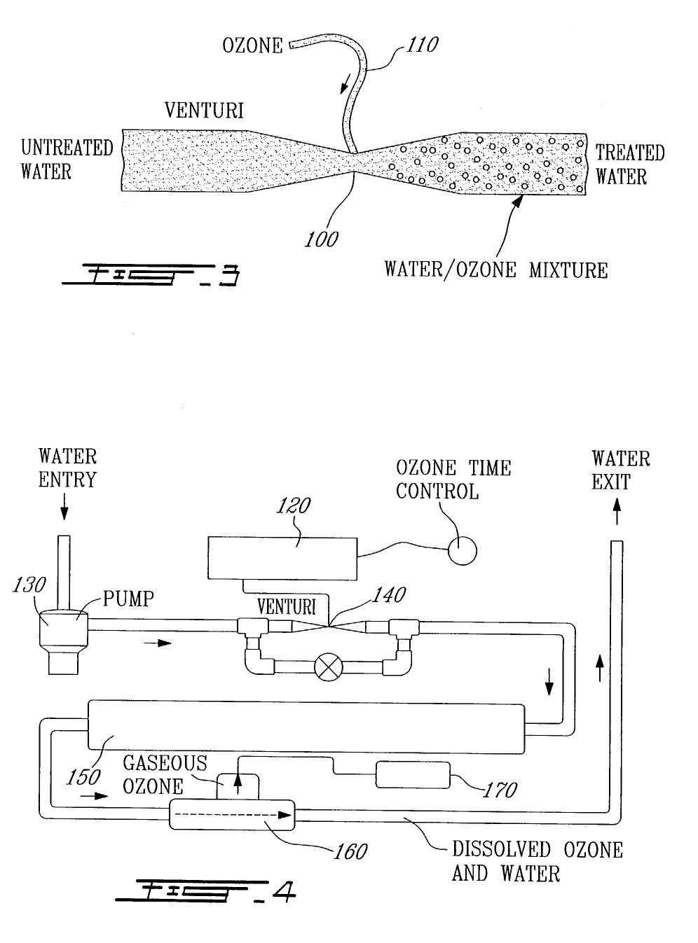

FIG. 3 shows an example venturi which may be used with the water purification system of the invention. A venturi is commonly used method of introducing ozone into a water stream.

A venturi functions by creating a bottle neck 100 in a stream of water. At the bottle neck 100 the a tube 110 is inserted. Ozone is then introduced at the bottle neck 100 through the tube 110. The result is that the stream of water becomes mixed with ozone, and the ozone is distributed through the entire water stream.

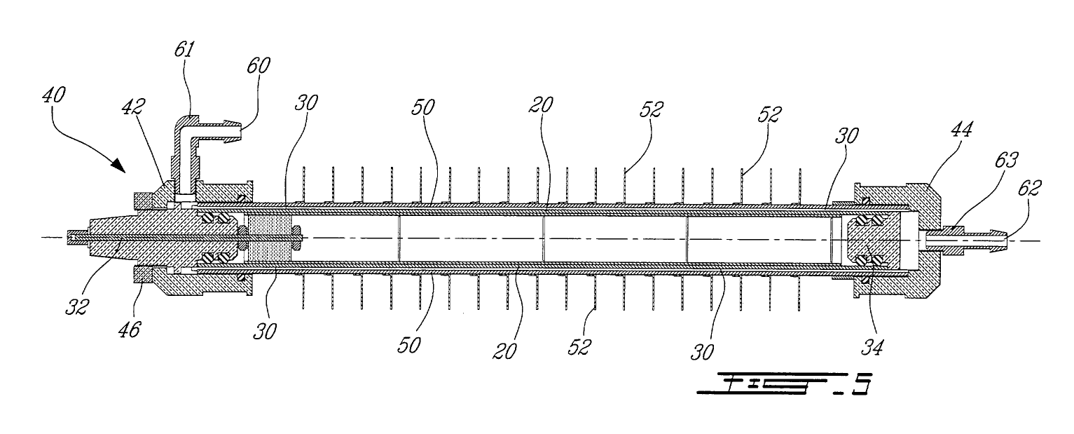

FIG. 4 shows a water treatment system according to one embodiment of the present invention. In this embodiment the system is configured to be used for small scale water treatment, for instance a swimming pool or a hot tub. This water treatment system comprises ozone generator means 120, which generates ozone to be introduced into the water. The ozone generator 10, shown in FIG. 2, is suitable for such use. In this application it is usually sufficient to have only a single ozone generator. In use, water is taken out of the water holding tank (the pool or tub, not shown) using pump 130 which pumps the water through the system.

Ozone generated by the ozone generator means 120 is then introduced into the water stream using a venturi 140. The water then flows into a reaction chamber 150, which is designed so as to allow the ozone to have sufficient contact time with the pollutants in the water stream so as to neutralize them. As the water flows into the reaction chamber it preferably passes through a diffuser (not shown) which ensures that the ozone is better diffused in the water stream.

After the water has spent sufficient time in the water chamber, which can either be a predetermined time based on calculated time needed to reduce expected amount of pollutants, or based on a reading of any remaining pollutants in the water, the water may be filtered before being moved on to an ozone separator 160.

The ozone separator 160 separates any remaining gaseous ozone from the water stream and sends the gaseous ozone to a ozone eliminator 170 to be destroyed. The treated water preferably still containing dissolved ozone, is then returned to the pool or spa.

FIGS. 5 and 6, show cross sections of one detailed embodiment of the ozone chamber 40 shown in FIG. 2. As can be seen in FIG. 5, the ozone chamber 40 is made up of end caps 42 and 44, an end fastening means 46, glass tube 30, glass tube support means 32 and 34, ground electrode 50, and air tube attachment means 61 and 63. As can be seen in FIG. 5, the ground electrode 50 has in this embodiment cooling fins 52, which allow the ozone chamber 40 to be more easily cooled.

Turning now to FIG. 6, we can see in greater detail the construction of the end caps 42 and 44, as well as the air flow within the ozone chamber 40.

Looking first at end cap 42, it can be seen that attached to an opening on the side of the end cap 40 is attached air tube attachment means 61. Air tube attachment means 61 has opening 60 through which the source gas of the ozone generator may enter the ozone chamber 40. Air tube attachment 61 is designed such that a source gas tube may easily be attached to it.

Also attached to end cap 42, is glass tube support means 32, which supports one end of the glass tube 30 within the ozone chamber 40. The glass tube support means also contains a connector cable 36 which through which power is supplied to the first electrode 20. The glass support means 32 is attached to end cap 42 by means of end fastening means 46 such that the attachment is air tight.

Looking now to end cap 44, it can be seen that end cap 44 also has an air tube attachment means 63. Air tube attachment means 63 has opening 62 through which ozone gas may exit the ozone chamber 40. The air tube attachment means 63 is also design such that an air tube may easily be attached to it. End cap 44 also contains glass tube support means 34 which supports one end of glass tube 30 within the ozone chamber 44.

FIG. 6, also shows the path of a gas passing through the ozone chamber 40. This path is indicated by arrow 48. As can be seen the supply gas enters the chamber through opening 60 in air tube attachment means 61, and is thereafter directed to the space 54 which exists between glass tube 30 and ground electrode 50. In this space the supply gas is subjected to the electrical discharge between the first electrode 20 and the ground electrode, thus causing oxygen in the gas to be turned into ozone. This ozone then continues to the other end of the ozone chamber 40, and exits through opening 62 in air tube attachment means 63.

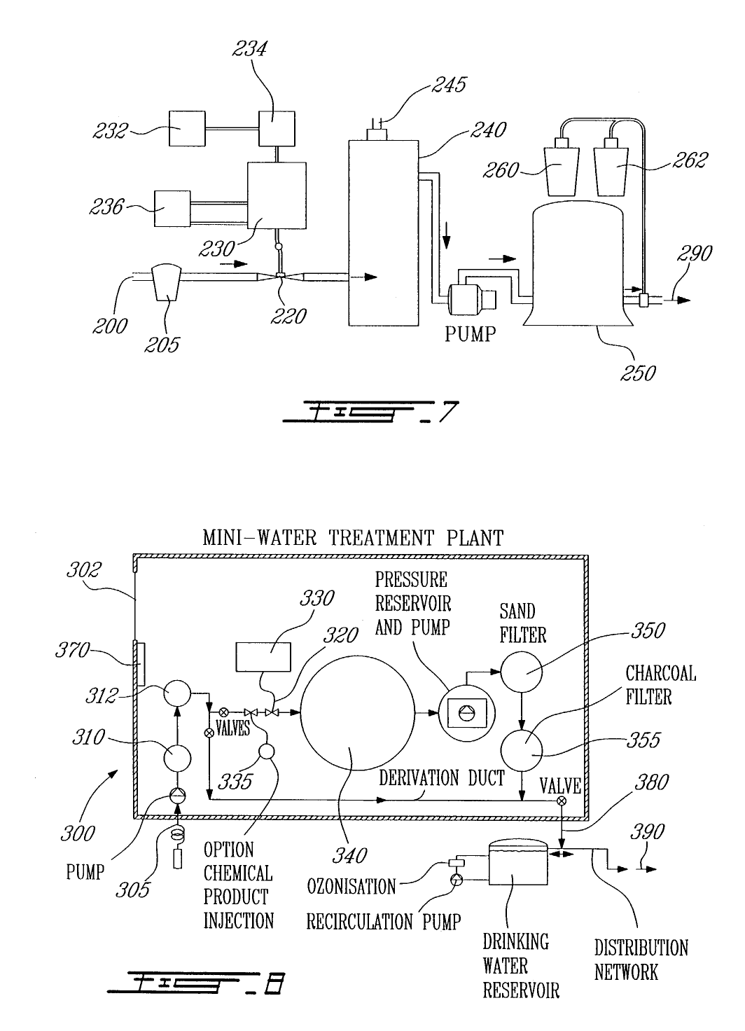

FIG. 7, shows water treatment system according to one embodiment of the invention. This water treatment system is designed for use with a potable water supply and uses a combination of ozone and chlorine. Chlorine is used because ozone is unstable and will only last for a short period of time. Therefore if the water does not reach its end destination before the breakdown time of the ozone the water risks becoming polluted again if the aqueduct is defective, which is often the case. Chlorine, however, is very stable and can therefore be used to keep the water clean from the time it leaves the water treatment system until it reaches its end destination. If the water is to be used closely, no chlorine treatment is necessary.

In the water treatment system shown in FIG. 7, a water stream will enter through entrance 200, and will pass through a screen 205. The screen 205 removes larger particles which can sometimes be found in untreated water.

The water then passes from the screen 205 to a venturi 220 where the water is injected with ozone produced by ozone generator 230. In this embodiment of the water treatment system, the ozone generator 230 includes several additional mechanisms which increase its efficiency. These are a preliminary air treatment means 232 which cools and dries the air destined for the ozone generator, and an oxygen generator means 234 which takes the cooled and dried air and separates the oxygen from the other gasses which naturally occur in air. As a result a much larger concentration of oxygen is fed into the ozone generator 230, thus making the ozone generation much more efficient and less likely to breakdown.

Finally, the ozone generator 230 is fitted with a water cooling system 236 which cools the ozone generator 230, and insures that it does not overheat again increasing its efficiency.

After the water stream has been injected with ozone, the water flows into a depressurized reaction chamber 240, wherein it is stored until the ozone has had sufficient time to react with the pollutants in the water. The depressurized reaction chamber can also include an ozone destroyer or vent 245 which removes any left over gaseous ozone from the chamber.

Finally, the water stream is passed through a sand filter 250 which removes the oxidised pollutants from the water stream. If required, the water stream is then injected with chlorine from storage tanks 260 and 262, before being sent to its final destination 290.

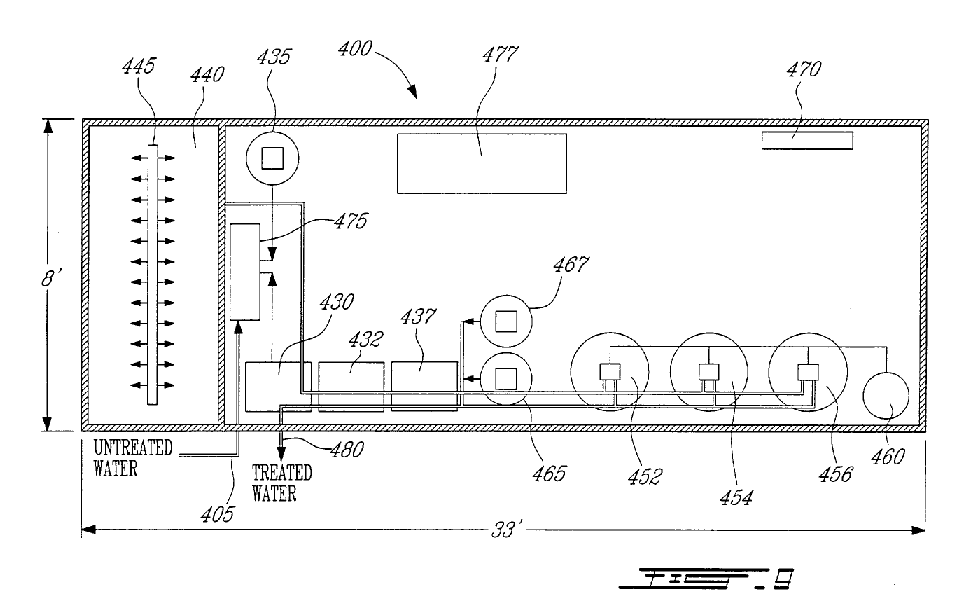

FIG. 8 shows another embodiment of the present invention, in which a complete water treatment system has been built into an easily transportable container. In this embodiment the water treatment system has been designed for compactness and ease of installation for a client. This embodiment is especially useful for large scale applications such as use as a small town's main potable water treatment facility. The reason for this is that large scale water treatment systems for, for instance municipal water treatment, often take up large amounts of space and require the construction of a building to house it.

Therefore, if the water treatment system was to be built on site, an even larger area would be needed and specialized workers would need to the present during the installation period. This is especially costly and inconvenient when the installation site is faraway. On the other hand if a water treatment system according to the present embodiment of the invention were to be used, then the water treatment system could be assembled and tested at a site distant from its final location. The water treatment system could then be easily transported to the final location and would simply need to be connected to the water network, and a suitable power supply.

As can be seen in FIG. 8, the water treatment system in the present embodiment may be situated in a standard container 300 (for example an 8 feet by 33 feet container). Water enters through entrance port 305 comprising a screen and passes through two filtration stages 310 and 312 in which larger (20 microns or more) particles are first removed and then smaller (5 microns or more) particles are removed. The water can then either be passed through an ozonisation cycle or just be cycled back into the water network if no treatment is required.

In the embodiment shown in FIG. 8, water going through an ozonisation stage may first be treated with other chemicals, for instance chlorine to reduce the amount of pollutants in the water before being injected with ozone produced by ozone generator 330 using a venturi 320. After being injected with ozone, the water is stored in a reaction chamber 340 for sufficient time to allow the ozone to react with the pollutants in the water.

After the appropriate time has passed, the water is passed through filters 350 and 355 before being sent into the water network 390.

The water treatment system of the embodiment shown in FIG. 8, additionally has an electrical control box 370 through with the water system can be controlled, and an entrance door 302 which allows access to the water treatment system.

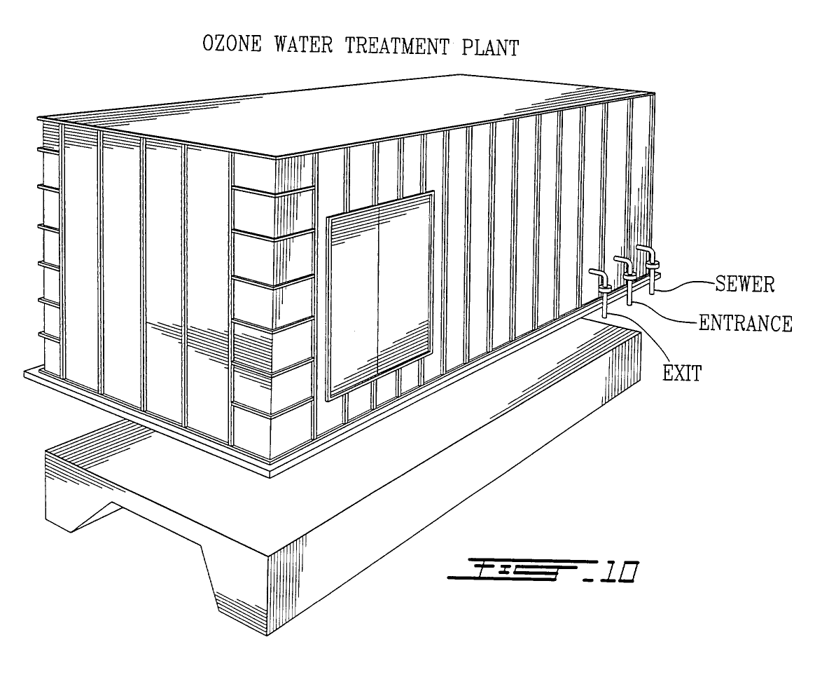

FIG. 9, shows another embodiment of a water treatment system 400 according to the invention which has been designed to be mobile and self contained. In this embodiment we can see the flow of water through the water treatment system 400. The water would enter the water treatment system 400, at point 405 and leave at point 480. As the water enters the water treatment system 400, it first comes to control station 475 where the water is treated with ozone produced by ozone generators 430 and 432 and other chemicals as needed to maintain the pH balance of the water.

This embodiment of the invention contains ozone generators 430 and 432 which are fitted with air dehumidifier and cooler 437. The chemical products needed to maintain the pH balance of the water are stored in contained 435.

After being ozonated the water is allowed to pass to a reaction chamber 440, containing a diffuser 445. The diffuser 445 works to diffuse the ozone in the water thereby increasing efficiency of the ozone. The water stays in the reaction chamber 440 for a time which is sufficient to allow the ozone to react with the pollutants in the water.

The water then passed to sand filters 452, 454, and 456 which work in parallel to filter out the ozonated pollutants of the water stream. The sand filters 452, 454, and 456 are also connected to chlorine reservoir 460 such that chlorine may be used to make sure the filters remain free of live bacteria.

Finally, the water stream passes by chlorine pumps 465 and 467 which may introduce chlorine in to the water stream to insure that the treated water will not be recontaminated when circulating in the water distribution network.

In this embodiment of the invention the water treatment system also includes a work post 477 at which a human operator may monitor the system, and a control panel 470 for controlling the system. FIG. 10, shows a possible housing for the embodiment of the water treatment system shown in FIGS. 8 and 9.

As can be seen from the previous embodiments the water treatment system of the present invention using the new ozone generator shown in FIG. 1, can easily be adapted to many different uses. Therefore, when designing a water treatment system it becomes important to analyse the water which is to be treated so that the water treatment system allows the treated water to meet the applicable standards and regulations.

When calculating the require size of the ozone generators for the water treatment system to be designed, there are primarily two factors which are the most important. These factors are the maximum water output, expressed in litres per minute or cubic metres per hour, and the total quantity of contaminants in the water.

To achieve a good result it then becomes necessary to have an ozone generator which can produce at least as much ozone which is necessary to clean the required amount of contaminants out of the required amount of water plus a safety factor.

In an example calculation for water commonly containing bacteria, iron, and manganese contaminants, lets say that bacteria require 0.8 mg of ozone per mg of contaminant, iron requires 0.5 mg of ozone per mg contaminant, and manganese requires 1.0 mg of ozone per mg of contaminant. Prior testing, with different water condition can be used to establish how much ozone is required to oxidise a certain quantity of contaminants.

Now, suppose a water system needs at maximum 32 L/min of water, and said water contains 1 mg/L of iron, 0.5 mg/L of manganese, and 1 mg/L of bacteria. Thus the system requires:

Ozone per litre=(mg/L of bacteria)*0.8+(mg/L of iron)*0.5+(mg/L of manganese)*1.0

=0.8+0.5+0.5

=1.8 mg/L

Thus the water treatment system would require an absolute minimum of: (32 L/min)*(1.8 mg/L)=57.6 mg/min=3.456 g/h of ozone. Then the selected safety factor can be applied.

As can be seen calculating the required amount ozone is quite simple after a detailed analysis of the amount of water required and the amount of pollutants per litre of water in the original contaminated source.

While the principles of this invention has been described in connection with specific embodiments, it should be understood clearly that these descriptions, along with the chosen examples and data, are made only by way of illustration and are not intended to limit the scope of this invention, in any manner. Various other ozonation systems and/or configurations can be used in conjunction with the invention. Many modifications and other embodiments of the invention will come to the mind of one skilled in the art having the benefit of the teachings presented in the foregoing descriptions and the associated drawings. No concerted attempt to repeat here what is generally known to the artisan has therefore been made. Therefore, it is to be understood that the invention is not to be limited to the specific embodiments disclosed, and that modifications and embodiments are intended to be included within the appended claims with the scope thereof determined by the reasonable equivalents, as understood by those skilled in the art.

1. A system for the treatment of water comprising:
c. ozone generator means for generating ozone gas;
d. venturi means for introducing said ozone gas into said water;
e. diffuser means for diffusing said ozone in said water; and
f. a contact chamber for allowing said ozone gas to dissolve in said water.

2. A water treatment system as claimed in claim 1, further comprising:
a. gas removal means for removing excess ozone gas from said water; and
b. ozone destruction means for destroying said excess ozone gas.

3. A water treatment system as claimed in claim 2, wherein said gas removal means comprises:
a. a chamber having one or more inlets through which water may enter said chamber, an ozone gaz collecting portion located near the top of said chamber and an ozone gas outlet connected to said gas collecting portion; and
b. a flotation device within said chamber, said flotation device being disposed such that when sufficient water is within said chamber said flotation device will close said outlet and will open said outlet when a predetermined quantity of ozone gas accumulates in said gas collecting portion.

4. A water treatment system as claimed in claim 1, wherein said ozone generator means further comprises:
a. ozone generation means having a first state in which the ozone generation means generates ozone, and a second state in which the ozone generation means does not generate ozone;
b. ozone detection means for determining how much ozone is being generated by the ozone generation means; and
c. a control circuit connected to said ozone detection means and said ozone generation means, such that said control circuit can cause the ozone generation means to pass from said first state to said second state if said measure is under a predetermined value.

5. A water treatment system as claimed in claim 1, wherein said ozone generator means further comprises:
a. ozone generation means having a first state in which the ozone generation means generates ozone and a second state in which the ozone generation means does not generate ozone;
b. current measuring means for determining how much current is being consumed by said ozone generation means;
c. control means connected to said current measuring means and said ozone generation means, such that said control circuit can cause the ozone generation means to pass from said first state to said second state if said measure is above a first predetermined value.

6. A water treatment system as claimed in claim 5 wherein said current measuring means and said control means are unitary.

7. A water treatment system as claimed in claim 5 wherein said control means are adapted to cause the ozone generation means to pass from said first state to said second state if said measure is under a second predetermined value.

8. A water treatment system as claimed in claim 5 wherein said the normal operation of said generation means draws an operating current and said first predetermined level is set as a percentage above said operating current.

9. A water treatment system as claimed in claim 7 wherein said the normal operation of said generation means draws an operating current and said second predetermined level is set as a percentage under said operating current.

10. A water treatment system as claimed in claim 8 wherein said percentage is about 30%.

11. A water treatment system as claimed in claim 9 wherein said percentage is about 30%.

12. A method for treating a water stream comprising the steps of:
a. providing an ozone generator means comprising:
i. an ozone generator having an first state in which the ozone generator generates ozone, and a second state in which the ozone generator does not generate ozone;
ii an ozone detection means for determining how much ozone is being generated by the ozone generator; and
iii a control circuit connected to said ozone detection means and said ozone generator, such that said control circuit can cause the ozone generator to pass from said first state to said second state if said measure is under a predetermined value;
b. determining how much ozone is needed to reduce a projected level of contaminants in the water stream to a harmless level;
c. introducing more ozone into the water than the needed amount of ozone;
d. maintaining the ozone in the water for a period of time sufficient to allow for:
i. the reduction of the projected level of contaminants; and
ii a predetermined quantity of ozone to become dissolved in said water.

13. A method for treating a water stream comprising the steps of:
a. providing an ozone generator means comprising:
i. an ozone generator having a first state in which the ozone generator generates ozone and a second state in which the ozone generator does not generate ozone;
ii. current measuring means for determining how much current is being consumed by said ozone generation means;
iii. control means connected to said current measuring means and said ozone generation means, such that said control circuit can cause the ozone generation means to pass from said first state to said second state if said measure is above a predetermined value.
b. determining how much ozone is needed to reduce a projected level of contaminants in the water stream to a harmless level;
c. introducing more ozone into the water than the needed amount of ozone;
d. maintaining the ozone in the water for a period of time sufficient to allow for:
i. the reduction of the projected level of contaminants; and
ii a predetermined quantity of ozone to become dissolved in said water.

14. A method as claimed in claim 13 wherein said current measuring means and said control means are unitary.

15. A water treatment system as claimed in claim 13 wherein said control means are adapted to cause the ozone generation means to pass from said first state to said second state if said measure is under a second predetermined value.

16. A water treatment system as claimed in claim 13 wherein said the normal operation of said generation means draws an operating current and said first predetermined level is set as a percentage above said operating current.

17. A water treatment system as claimed in claim 15 wherein said the normal operation of said generation means draws an operating current and said second predetermined level is set as a percentage under said operating current.

18. A water treatment system as claimed in claim 16 wherein said percentage is about 30%.

19. A water treatment system as claimed in claim 17 wherein said percentage is about 30%.

20. A method for treating water as claimed in claim 13 further comprising the step of removing the excess ozone from the water stream.

21. A method for treating a water stream as claimed in claim 13, further comprising the steps of using a diffuser means to mix the ozone in the water to obtain better distribution of the ozone in the water.

22. A water treatment system as claimed in claim 2, wherein all said means are installed in an enclosure such that the water treatment system can be relocated by moving the enclosure and such that the water treatment system can treat a water source external to said enclosure without being removed from said enclosure.

23. A water treatment system as claimed in claim 22 wherein the enclosure is a freight container.

24. A method of installing a water treatment system using an ozone generator means at an installation location, said method comprising the steps of:
a. building the water treatment system at a location remote to the installation location;
b. installing the water treatment system in an enclosure such that the water treatment system can be relocated by moving the enclosure, and such that the water treatment system can treat a water source external to said enclosure without being removed from said enclosure;
c. transporting said enclosure to the installation location; and
d. installing the enclosure at the installation location.

25. A method as claimed in claim 24 wherein said housing is a freight container.

26. An ozone generating apparatus comprising:
a. an outer cylinder made out of an electrically conducting and ozone resistant material, said outer cylinder extending along a longitudinal central axis and having a first end and a second end;
b. an intermediate cylinder made of glass or quartz, said intermediate cylinder extending along said axis within said outer cylinder and defining an outer chamber with said outer cylinder and having a third end and a fourth end;
c. an inner cylinder made out of an electrically conducting material, said inner cylinder extending along said axis within said intermediate cylinder and forming an inner chamber;
d. a first plug made of an ozone resistant material adapted to seal said first end and defining an oxygen containing gas inlet;
e. a second plug made of an ozone resistant material adapted to seal said second end and defining an ozone outlet;
f. a third plug made of an ozone resistant material adapted to seal said third end;
g. a fourth plug made of an ozone resistant material adapted to seal said fourth end;
h. an electrode in electrical contact with said inner cylinder and adapted to be connected to an external power source;
wherein a continuous gas path is defined between said inlet and said outlet and said apparatus may be easily disassembled for cleaning.

27. An ozone generating apparatus as claimed in claim 26 wherein said first plug is frictionally attached to said first end.

28. An ozone generating apparatus as claimed in claim 27 wherein said third plug is frictionally attached to said third end.

29. An ozone generating apparatus as claimed in claim 28 wherein said second plug is frictionally attached to said second end.

30. An ozone generating apparatus as claimed in claim 29 wherein said fourth plug is frictionally attached to said fourth end.

31. An ozone generating apparatus as claimed in claim 26, wherein said outer cylinder is made of stainless steel.

32. An ozone generating apparatus as claimed in claim 26, wherein no tools are required to disassemble said apparatus.
